(19) United States
(12) Patent Application Publication
(10) Pub. No.: US 2025/0129262 A1
(43) Pub. Date: Apr. 24, 2025

(54) UREA COATING COMPOSITION

(71) Applicant: KCC CORPORATION, Seoul (KR)

(72) Inventors: Jung Rim OK, Jeonju-si (KR); Seong Uk JANG, Wanju-gun (KR); Kang Hoon JUNG, Wanju-gun (KR)

(21) Appl. No.: 18/917,960

(22) Filed: Oct. 16, 2024

(30) Foreign Application Priority Data
Oct. 24, 2023 (KR) 10-2023-0142769
Oct. 4, 2024 (KR) 10-2024-0134589

(51) Int. Cl. C09D 175/02; C08G 18/28; C08G 18/32; C08G 18/34; C08G 18/76; C09D 7/20

(52) U.S. Cl. CPC C09D 175/02; C08G 18/282; C08G 18/284; C08G 18/3234; C08G 18/346; C08G 18/7664; C09D 7/20

(57) ABSTRACT

Provided is a urea coating composition that has excellent weather resistance and excellent durability. The urea coating composition provided herein possesses both the hardness of the epoxy coating and the elongation rate of the urethane coating, and it has excellent weather resistance and excellent properties of the coating film and thus is suitable for application for coating exterior walls. The urea coating composition provided herein may be applied to the eco-friendly coating of exterior walls of buildings, top coats of waterproof floor materials, DTM (Direct To Metal), and the like, and it may be applied not only for thin film coating but also for thick film coating due to possessing excellent surface hardness and mechanical properties. In addition, the urea coating composition provided herein is a coating composition containing a low content of solvent, and thus it is eco-friendly due to the small generation of volatile organic compounds (VOCs).

### BACKGROUND

### 1. Field

The present invention relates to a urea coating composition that has excellent weather resistance and excellent durability.

### 2. Description of the Related Art

The interior and exterior surfaces of buildings, such as floors and walls, are composed of various base materials such as concrete, wood, brick, steel, marble, terrazzo, ceramics, metal plates, and synthetic resins, and various coatings are formed on the exterior surfaces to protect them from physical abrasion, scratches, stains, chemical damage, and the like. As the coating for surface protection, aqueous epoxy coating, urethane coating, and the like have been generally used.

For example, Korean Patent Laid-open No. 10-2016-0144172 discloses an epoxy coating composition that contains a main part containing a liquid bisphenol A-type epoxy resin, a reactive thinner, a non-reactive thinner, a plasticizer, a dispersing agent, an ultraviolet stabilizer, an antifoaming agent, and a sedimentation preventive agent and a curing part. However, in the case of the epoxy coating, there is a limitation in that yellowing occurs or the long-term weather resistance is poor due to a low elongation rate.

On the other hand, in the case of the urethane coating, although the elongation rate is excellent, there is a limitation in that tensile strength and weather resistance are inferior, and thus periodic maintenance is required. Polyurea coating has been proposed to solve such limitations, however, the polyurea coating requires an expert and an expensive spray device for coating work and has a limitation in that yellowing occurs due to chemical structural defects.

As a result, there is a demand for the development of a coating composition that has both excellent hardness and an excellent elongation rate and thus has excellent weather resistance and excellent durability.

### SUMMARY

The present invention provides a urea coating composition that has excellent weather resistance and excellent durability.

The present invention provides a urea coating composition comprising a main part comprising a first aspartic ester and a second aspartic ester at a weight ratio of 3.5 to 5:1 and a curing part comprising an isocyanate.

The present invention provides a urea coating composition that has excellent weather resistance and excellent durability. The urea coating composition according to the present invention possesses both the hardness of the epoxy coating and the elongation rate of the urethane coating, and it has excellent weather resistance and excellent properties of the coating film and thus is suitable for application for coating exterior walls. The urea coating composition according to the present invention may be applied to the eco-friendly coating of exterior walls of buildings, top coats of waterproof floor materials, DTM (Direct To Metal), and the like, and it may be applied not only for thin film coating but also for thick film coating due to possessing excellent surface hardness and mechanical properties. In addition, the urea coating composition according to the present invention is a coating composition containing a low content of solvent, and thus it is eco-friendly due to the small generation of volatile organic compounds (VOCs).

### DETAILED DESCRIPTION

Hereinafter, the present invention will be described in detail. However, the present invention is not limited to the following contents, and each component may be variously modified or may be optionally mixed as necessary. Therefore, it should be understood to include all modifications, equivalents, or substitutes, which are included in the scope of thought and technology of the present invention.

The “weight average molecular weight” to be used in the present specification is measured by a conventional method known in the field of the related art, and it can be measured by, for example, a gel permeation chromatography (GPC) method. A functional group value such as a “hydroxyl group value” and “amine value”, is measured by a conventional method known in the field of the related art, and it can be measured by, for example, a titration method.

The urea coating composition according to the present invention comprises a main part comprising an aspartic ester and a curing part comprising an isocyanate.

### <Main Part>

### Aspartic Ester

The main part of the urea coating composition according to the present invention contains an aspartic ester. The urea coating composition according to the present invention uses an aspartic ester as a resin of the main part. Therefore, a coating film can be formed by a urea reaction which is a reaction that may be carried out without a catalyst, and working life may be adjusted due to the steric hindrance during the reaction, which allows work to be relaxed.

Aspartic esters are classified into a fast drying aspartic ester, a standard aspartic ester, a slow drying aspartic ester, and an ultra-slow drying aspartic ester based on the reaction rate. The reaction rate of the aspartic ester is evaluated by mixing an aspartic ester with an isocyanate (an HDI trimer) at room temperature (25° C.) at a ratio of 1:1 in terms of equivalent number and then measuring the time taken until the curing is completed. The classification is made such that an aspartic ester is classified into a fast drying aspartic ester in a case where the time of the completion of curing is less than 15 minutes, an aspartic ester is classified into a standard aspartic ester in a case where the time of the completion of curing is 20 minutes to 40 minutes, an aspartic ester is classified into a slow drying aspartic ester in a case where the time of the completion of curing is 60 minutes to 100 minutes, and an aspartic ester is classified into an ultra-slow aspartic ester in a case where the time of the completion of curing is 160 minutes to 200 minutes.

In the present invention, the aspartic ester comprises a first aspartic ester and a second aspartic ester.

An aspartic ester may be produced by a reaction between an amine such as para-diaminodicyclohexylmethane (PACM) or 3,3′-dimethyl-4,4′-diaminodicyclohexylmethane (DMDC) and a maleate such as dibutyl maleate (DBM) or diethyl maleate (DEM).

The first aspartic ester is a standard aspartic ester and has an alicyclic structure, and thus can provide excellent hardness to the coating composition. The first aspartic ester may be produced by a reaction between an alicyclic amine and a maleate. For example, the first aspartic ester may be tetraethyl N,N′-(methylenedi-4,1-cyclohexanediyl)bis(aspartate) which is produced by reacting para-diaminodicyclohexylmethane (PACM) with dibutyl maleate (DBM).

The weight average molecular weight of the first aspartic ester may be 300 to 1,000 g/mol, for example, 400 to 550 g/mol. In a case where the weight average molecular weight is smaller than the range described above, the effect of the steric hindrance may be reduced, thereby making the curing fast, and in a case where the weight average molecular weight exceeds the range described above, the effect of the steric hindrance may be increased, thereby making the curing very slow.

The amine equivalent of the first aspartic ester may be 100 to 500 g/eq, for example, 250 to 350 g/eq. In a case where the amine equivalent is smaller than the range described above, the curing may not fully proceed due to the lack of the NCO reactive group in the curing part during the reaction between the main part and the curing part, and in a case where the amine equivalent exceeds the range described above, the appearance of the coating film may be not good due to the excessiveness of the NCO reactive group in the curing part part during the reaction between the main part and the curing part.

The amine value of the first aspartic ester may be 50 to 350 mgKOH/g, for example, 150 to 250 mgKOH/g. In a case where the amine value is smaller than the range described above, the curing may not fully proceed due to the lack of the NCO reactive group in the curing part during the reaction between the main part and the curing part, and in a case where the amine value exceeds the range described above, the appearance of the coating film may be not good due to the excessiveness of the NCO reactive group in the curing part during the reaction between the main part and the curing part.

The urea coating composition according to the present invention may contain 60 to 70% by weight of the first aspartic ester, for example, 62 to 68% by weight thereof, based on the total weight of the main part. In a case where the content of the first aspartic ester is smaller than the range described above, the reactivity may be lowered, thereby making the curing slow, and in a case where the content of the first aspartic ester exceeds the range described above, the working time may be shortened due to the high reactivity.

The second aspartic ester is an ultra-slow drying aspartic ester and has an alicyclic structure containing an alkyl group. The second aspartic ester may be produced by a reaction between an alkyl group-containing alicyclic amine and a maleate. For example, the second aspartic ester may be produced by a reaction between 3,3′-dimethyl-4,4′-diaminodicyclohexylmethane (DMDC) and diethyl maleate (DEM).

The weight average molecular weight of the second aspartic ester may be 300 to 1,000 g/mol, for example, 350 to 550 g/mol. In a case where the weight average molecular weight is smaller than the range described above, the curing may not fully proceed due to the lack of the NCO reactive group in the curing part during the reaction between the main part and the curing part, and in a case where the weight average molecular weight exceeds the range described above, the appearance of the coating film may be not good due to the excessiveness of the NCO reactive group in the curing part during the reaction between the main part and the curing part.

The amine equivalent of the second aspartic ester may be 100 to 500 g/eq, for example, 250 to 350 g/eq. In a case where the amine equivalent is smaller than the range described above, the curing may not fully proceed due to the lack of the NCO reactive group in the curing part during the reaction between the main part and the curing part, and in a case where the amine equivalent exceeds the range described above, the appearance of the coating film may be not good due to the excessiveness of the NCO reactive group in the curing part during the reaction between the main part and the curing part.

The amine value of the second aspartic ester may be 50 to 350 mgKOH/g, for example, 150 to 250 mgKOH/g. In a case where the amine value is smaller than the range described above, the curing may not fully proceed due to the lack of the NCO reactive group in the curing part during the reaction between the main part and the curing part, and in a case where the amine value exceeds the range described above, the appearance of the coating film may be not good due to the excessiveness of the NCO reactive group in the curing part during the reaction between the main part and the curing part.

The urea coating composition according to the present invention may contain 10 to 20% by weight of the second aspartic ester, for example, 12 to 18% by weight thereof, based on the total weight of the main part. In a case where the content of the second aspartic ester is smaller than the range described above, the effect on the reaction may be insufficient, thereby making the working life short, and in a case where the content of the second aspartic ester exceeds the range described above, the curing may be delayed since the reaction rate is slowed down.

The first aspartic ester and the second aspartic ester may be used at a weight ratio of 3.5 to 5:1. In a case where the above-described two aspartic esters are used at the mixing ratio described above, it is possible to provide a coating composition that has excellent weather resistance and is capable of being cured at ordinary temperature. In a case where the mixing ratio of the first aspartic ester to the second aspartic ester is smaller than the range described above, the solidification and drying may be slowed down, and in a case where the mixing ratio of the first aspartic ester to the second aspartic ester exceeds the range described above, the working time may be shortened and thus the workability may be reduced.

### High-Boiling VOC Exempt Solvent

The main part of the urea coating composition according to the present invention may further contain a high-boiling VOC exempt solvent. The high-boiling VOC exempt solvent decreases the viscosity to increase the convenience of working, and inhibits the reaction to delay the rapid curing and extends the working time. The boiling point of the high-boiling VOC exempt solvent may be 80° C. or higher, for example, 80 to 150° C. If the boiling point is low, it may be vulnerable to explosion and fire, and defects in the appearance of the coating, such as pinholes, cratering, etc., may occur due to the fast evaporation rate of the solvent. In addition, the high-boiling VOC exempt solvent is low toxic and highly biodegradable, which has less impact on human health and the environment, is recyclable and therefore environmentally friendly, and is chemically stable and do not react easily with other substances. Therefore, the high-boiling VOC exempt solvent is often used as a solvent.

As the high-boiling VOC exempt solvent, those known as high-boiling VOC exempt solvents in the field of the related art can be used without any particular limitation. For example, dimethyl carbonate, parachlorobenzotrifluoride, and the like can be used as the high-boiling VOC exempt solvent. They may be used alone or in combination with two or more. For example, the high-boiling VOC exempt solvent may comprise dimethyl carbonate.

The urea coating composition according to the present invention may contain 1 to 10% by weight of the high-boiling VOC exempt solvent, for example, 3 to 7% by weight thereof, based on the total weight of the main part. In a case where the content of the high-boiling VOC exempt solvent is smaller than the range described above, the viscosity of the coating may not proper, or working time may be shortened due to the high reactivity, thereby reducing workability, and in a case where the content of the high-boiling VOC exempt solvent exceeds the range described above, the normal reaction of the coating may be inhibited, resulting in slower drying or reduced film thickness.

### Chain Extender

The main part of the urea coating composition according to the present invention may further contain a chain extender. The chain extender increases the degree of bonding between respective components in a coating composition, thereby playing a role in improving the properties of the coating film, such as tensile strength and elongation rate.

The chain extender may include one or more selected from the group consisting of diols such as ethylene glycol, propylene glycol, 1,4-butanediol; triols such as glycerin and trimethylolpropane; tetraols such as pentaerythritol and oxypropylated ethylenediamine; diamines such as hexamethylenediamine and m-phenylenediamine; and amino alcohols such as diethanolamine and triethanolamine, and the like.

The weight average molecular weight of the chain extender may be 150 to 500 g/mol, for example, 250 to 350 g/mol. In a case where the weight average molecular weight is smaller than the range described above, the effect of chain extension may be low since the chain length is too short, which makes the effect of increasing the degree of elongation insufficient. In a case where the weight average molecular weight exceeds the range described above, the degree of crosslinking between chains may be increased, which weakens the degree of elongation or reduces the kneading properties of the resin.

The amine equivalent of the chain extender may be 50 to 300 g/eq, for example, 100 to 200 g/eq. In a case where the amine equivalent is smaller than the range described above, the chain extension effect may be insufficient due to low reactivity, and in a case where the amine equivalent exceeds the range described above, the degree of crosslinking between chains may be increased, which weakens the degree of elongation or reduce the kneading properties of the resin.

The amine value of the chain extender may be 250 to 550 mgKOH/g, for example, 350 to 450 mgKOH/g. In a case where the amine value is smaller than the range described above, the chain extension effect may be insufficient due to weak reactivity, and in a case where the amine value exceeds the range described above, the degree of crosslinking between chains may be increased, which weakens the degree of elongation or reduce the kneading properties of the resin.

The urea coating composition according to the present invention may contain 1 to 10% by weight of the chain extender, for example, 3 to 7% by weight thereof, based on the total weight of the main part. In a case where the content of the chain extender is smaller than the range described above, the properties of the coating film, such as tensile strength, elongation, etc., may be degraded because the binding parts in the urea reaction are not long enough, and in a case where the content of the chain extender exceeds the range described above, excessive curing and increase in surface hardness due to excessive chain extension effect may occur, causing the coating film to become brittle or crack easily.

### Additive

The main part of the urea coating composition according to the present invention may contain additives known in the field of the related art as long as the inherent characteristics of the above-described composition are not impaired. Non-limited examples of the additives that are capable of being used include an antisagging agent (for example, wax), an antifoaming agent (for example, a silicone-based antifoaming agent), a moisture absorbing agent, and a plasticizer (for example, dioctyl terephthalate), leveling agent.

The contents of the additives can be adjusted within the content range publicly known in the field of the related art, and for example, each of the contents of the additives may be 0.1 to 10% by weight based on the total weight of the main part.

### <Curing Part>

The curing part of the urea coating composition according to the present invention contains an isocyanate. Since the urea coating composition according to the present invention uses an isocyanate as the resin of the curing part, the UV light stability can be secured. In the urea coating composition according to the present invention, the aspartic ester of the main part and the isocyanate of the curing part cause a urea reaction, and thus the urea coating composition according to the present invention can have both the excellent hardness of the epoxy coating composition and the excellent elongation rate of the urethane coating composition, which are the advantages of the urea composition.

The isocyanate may be a low-viscosity aliphatic isocyanate. The isocyanate may include one or more selected from the group consisting of a hexamethylene diisocyanate trimer (HDI trimer), a hexamethylene diisocyanate burette (HDI biuret), an isophorone diisocyanate trimer (IPDI), and the like.

A part of the functional groups of the isocyanate may be capped. For example, a part of the functional groups of the isocyanate can be capped with an amino silane. In this case, an uncapped functional group is bonded to the aspartic ester of the main part to form a urea bond, whereby the reaction rate can be slowed down. In addition, the main chain of the coating film is allowed to have a silane functional group by introducing an amino silane into the curing part, which makes it possible to increase the adhesive force during the formation of the coating film.

The NCO content of the isocyanate is 15 to 25%, and the viscosity (25° C.) thereof may be 100 to 1,000 cPs, for example, 300 to 700 cPs. In a case where the NCO content is smaller than the range described above, the curing of the coating film may proceed insufficiently due to the small number of NCO reactive groups, and in a case where the NCO content exceeds the range described above, the appearance of the coating film may be poor due to the excessiveness of the NCO reactive group. In a case where the viscosity is smaller than the range described above, the thickness of the coating film may be thin, and in a case where the viscosity exceeds the range described above, the workability may be deteriorated.

The urea coating composition according to the present invention may contain 63 to 75% by weight of the isocyanate, for example, 65 to 72% by weight thereof, based on the total weight of the curing part. In a case where the isocyanate content is smaller than the range described above, the curing of the coating film may proceed insufficiently due to the small number of NCO reactive groups, and in a case where the isocyanate content exceeds the range described above, the appearance of the coating film may be poor due to the excessiveness of the NCO reactive group.

The curing part of the urea coating composition according to the present invention may further contain a monomolecular alcohol. The monomolecular alcohol can improve elongation by capping the NCO. The monomolecular alcohol may include one or more selected from the group consisting of texanol, ethanol, and the like. The molecular weight of the monomolecular alcohol is 150 to 250 g/mol, and the hydroxyl group value thereof may be from 200 to 350 mgKOH/g.

The urea coating composition according to the present invention may contain 1 to 10% by weight of the monomolecular alcohol, for example, 3 to 7% by weight thereof, based on the total weight of the curing part. In a case where the content of monomolecular alcohol is smaller than the range described above, the appearance of the coating film may be poor due to the excessiveness of the NCO reactive group, and in a case where the content of monomolecular alcohol exceeds the range described above, the curing of the coating film may proceed insufficiently due to the small number of NCO reactive groups.

The curing part of the urea coating composition according to the present invention may contain additives known in the field of the related art as long as the inherent characteristics of the above-described composition are not impaired. Non-limited examples of the additive that is capable of being used include an adhesion enhancer (for example, an amino silane), solvents.

The curing part of the urea coating composition according to the present invention may contain 10 to 25% by weight of the adhesion enhancer, for example, 15 to 20% by weight thereof, based on the total weight of the curing part. In a case where the content of the adhesion enhancer is smaller than the range described above, the adhesibility may be degraded, and in a case where the content of the adhesion enhancer exceeds the range described above, the physical properties of the coating film may be degraded.

The contents of the additives besides the adhesion enhancer can be adjusted within the content range publicly known in the field of the related art, and for example, each of the contents of the additives may be 0.1 to 10% by weight, for example, 0.1 to 8% by weight based on the total weight of the curing part.

The main part and the cutting part may be used at a weight ratio of 0.5 to 1.2:1, for example, 0.5 to 0.7:1, for another example, 0.6 to 0.65:1. In a case where the mixing ratio of the main part to the curing part is smaller than the range described above, High NCO content may cause drying delays and other problems, and in a case where the mixing ratio of the main part to the cutting part exceeds the range described above, adhesibility may be degraded due to the fast reaction.

Hereinafter, the present invention will be described in more detail through exemplary embodiments. However, the following exemplary embodiments are merely for the assistance of the understanding of the present invention, and the scope of the present invention is not limited to the exemplary embodiments in any sense.

### Experimental Examples 1 to 18

According to the composition in Table 1 to 3 below, each coating composition of the experimental examples was produced.

TABLE 1

| | Component | Experimental example | | | | | |
|---|---|---|---|---|---|---|---|
| | (parts by weigh) | 1 | 2 | 3 | 4 | 5 | 6 |
| Main | First aspartic ester | 63 | 65 | 67 | 68 | 64 | 65 |
| part | Second aspartic ester | 18 | 16 | 14 | 15 | 15 | 16 |
| | VOC exempt solvent | 5 | 5 | 5 | 3 | 7 | 5 |
| | Chain extender | 6 | 6 | 6 | 6 | 6 | 6 |
| | Antisagging agent | 0.5 | 0.5 | 0.5 | 0.5 | 0.5 | 0.5 |
| | Antifoaming agent 1 | 1 | 1 | 1 | 1 | 1 | 1 |
| | Antifoaming agent 2 | 2 | 2 | 2 | 2 | 2 | 2 |
| | Moisture absorbing | 0.5 | 0.5 | 0.5 | 0.5 | 0.5 | 0.5 |
| | agent | | | | | | |
| | Plasticizer | 4 | 4 | 4 | 4 | 4 | 4 |
| | Total | 100 | 100 | 100 | 100 | 100 | 100 |
| Curing | Isocyanate | 69 | 69 | 69 | 69 | 69 | 65 |
| part | Monomolecular | 6 | 6 | 6 | 6 | 6 | 7 |
| | alcohol | | | | | | |
| | Adhesion enhancer | 17 | 17 | 17 | 17 | 17 | 20 |
| | Solvent | 8 | 8 | 8 | 8 | 8 | 8 |
| | Total | 100 | 100 | 100 | 100 | 100 | 100 |

| | | | | | | |
|---|---|---|---|---|---|---|
| Main part:Curing part | 0.6:1 | 0.6:1 | 0.6:1 | 0.6:1 | 0.6:1 | 0.6:1 |
| (weight ratio) | | | | | | |
| First aspartic ester/Second | 3.50 | 4.06 | 4.79 | 4.53 | 4.27 | 4.06 |
| aspartic ester | | | | | | |
| (weight ratio) | | | | | | |

TABLE 2

| | Component | Experimental example | | | | | |
|---|---|---|---|---|---|---|---|
| | (parts by weigh) | 7 | 8 | 9 | 10 | 11 | 12 |
| Main | First aspartic ester | 65 | 70 | 70 | 59 | 55 | 71 |
| part | Second aspartic ester | 16 | 16 | 16 | 22 | 26 | 10 |
| | VOC exempt solvent | 5 | | | 5 | 5 | 5 |
| | Chain extender | 6 | 6 | 6 | 6 | 6 | 6 |
| | Antisagging agent | 0.5 | 0.5 | 0.5 | 0.5 | 0.5 | 0.5 |
| | Antifoaming agent 1 | 1 | 1 | 1 | 1 | 1 | 1 |
| | Antifoaming agent 2 | 2 | 2 | 2 | 2 | 2 | 2 |
| | Moisture absorbing | 0.5 | 0.5 | 0.5 | 0.5 | 0.5 | 0.5 |
| | agent | | | | | | |
| | Plasticizer | 4 | 4 | 4 | 4 | 4 | 4 |
| | Total | 100 | 100 | 100 | 100 | 100 | 100 |
| Curing | Isocyanate | 72 | 63 | 75 | 69 | 69 | 69 |
| part | Monomolecular | 5 | 5 | 2 | 6 | 6 | 6 |
| | alcohol | | | | | | |
| | Adhesion enhancer | 15 | 24 | 15 | 17 | 17 | 17 |
| | Solvent | 8 | 8 | 8 | 8 | 8 | 8 |
| | Total | 100 | 100 | 100 | 100 | 100 | 100 |

| | | | | | | |
|---|---|---|---|---|---|---|
| Main part:Curing part | 0.6:1 | 0.6:1 | 0.6:1 | 0.6:1 | 0.6:1 | 0.6:1 |
| (weight ratio) | | | | | | |
| First aspartic ester/ | 4.06 | 4.38 | 4.38 | 2.68 | 2.12 | 7.10 |
| Second aspartic ester | | | | | | |
| (weight ratio) | | | | | | |

TABLE 3

| | Component | Experimental example | | | | | |
|---|---|---|---|---|---|---|---|
| | (parts by weigh) | 13 | 14 | 15 | 16 | 17 | 18 |
| Main | First aspartic ester | 74 | 67 | 72 | 72 | 81 | |
| part | Second aspartic ester | 7 | 9 | 14 | 14 | | 81 |
| | VOC exempt solvent | 5 | 10 | | | 5 | 5 |
| | Chain extender | 6 | 6 | 6 | 6 | 6 | 6 |
| | Antisagging agent | 0.5 | 0.5 | 0.5 | 0.5 | 0.5 | 0.5 |
| | Antifoaming agent 1 | 1 | 1 | 1 | 1 | 1 | 1 |
| | Antifoaming agent 2 | 2 | 2 | 2 | 2 | 2 | 2 |
| | Moisture absorbing | 0.5 | 0.5 | 0.5 | 0.5 | 0.5 | 0.5 |
| | agent | | | | | | |
| | Plasticizer | 4 | 4 | 4 | 4 | 4 | 4 |
| | Total | 100 | 100 | 100 | 100 | 100 | 100 |
| Curing | Isocyanate | 69 | 69 | 60 | 76 | 69 | 69 |
| part | Monomolecular | 6 | 6 | 6 | 6 | 6 | 6 |
| | alcohol | | | | | | |
| | Adhesion enhancer | 17 | 17 | 26 | 10 | 17 | 17 |
| | Solvent | 8 | 8 | 8 | 8 | 8 | 8 |
| | Total | 100 | 100 | 100 | 100 | 100 | 100 |

| | | | | | | |
|---|---|---|---|---|---|---|
| Main part:Curing part | 0.6:1 | 0.6:1 | 0.6:1 | 0.6:1 | 0.6:1 | 0.6:1 |
| (weight ratio) | | | | | | |
| First aspartic ester/Second | 10.57 | 7.44 | 5.14 | 5.14 | — | 0.00 |
| aspartic ester | | | | | | |
| (weight ratio) | | | | | | |

First aspartic ester: A reaction product of para-diaminodicyclohexylmethane (PACM) and dibutyl maleate (DBM) (mixing ratio (in terms of weight ratio) is 38:62), Mw: 449 g/mol, amine equivalent: 279±2 g/eq, amine value: 200±10 mgKOH/g

Second aspartic ester: A reaction product of 3,3′-dimethyl-4,4′-diaminodicyclohexylmethane (DMDC) and diethyl maleate (DEM) (mixing ratio (in terms of weight ratio) is 41:59), Mw: 463 g/mol, amine equivalent: 290±2 g/eq, amine value: 190±2 mgKOH/g

VOC exempt solvent: Dimethyl carbonate

Chain extender: Isophorone diamine (IPDA)+Isobutyl aldehyde (IBA) (Vestamine A-139, EVONIC Industries AG, Mw: 278±10 g/mol, amine equivalent: 140±5 g/eq, amine value: 400 mgKOH/g)

Antisagging agent: Wax (HPA-220X)

Antifoaming agent 1: BYK-066N

Antifoaming agent 2: BYK-054

Moisture absorbing agent: Luthamine AD-1

Plasticizer: DOTP (Dioctyl terephthalate)

Isocyanate: Low viscosity HDI trimmer (HT-300, NCO: 20±2%, viscosity (25° C.): 500 cPs)

Monomolecular alcohol: AAE-200A

Adhesion enhancer: Amino silane (A-1170)

Solvent: Propylene carbonate

### [Evaluation of Properties]

The properties of the coating film formed according to each experimental example were measured according to the following method, and the results are shown in Tables 4 to 6 below.

### Tensile Strength

A test method described in KS F 3211 Waterproofing Coating for Construction was carried out.

### Elongation Rate

A test method described in KS F 3211 Waterproofing Coating for Construction was carried out.

### Durability

A test method described in KS F 3211 Waterproofing Coating for Construction was carried out.

### Hardness of Coating Film

A coating film (thickness: 2 mm) was completely dried, and then the hardness of the coating film was measured using a Shore A hardness tester.

### Solidification and Drying

The time taken until fingerprints were not observed on the coating film was measured in a case where a test piece of the coating film was held with the thumb and the index finger, the coating film was pressed hard without being twisted, subsequently removed, and then lightly wiped with a soft cloth. When the solidification and drying time is 18 hours or less, the property was evaluated as excellent.

### Adhesion

Adhesion was evaluated according to ASTM D3359.

### Working Life

Each of the main part and the curing part were mixed, and then the time for reaching 300,000 cps was measured while carrying out the operation at 25° C. with a Brookfield #7, at 10 rpm. When the working life is 80 to 120 minutes, the property was evaluated as excellent.

TABLE 4

| | | | Experimental example | | | | | |
|---|---|---|---|---|---|---|---|---|
| Item | | | 1 | 2 | 3 | 4 | 5 | 6 |
| Tensile strength (MPa) | | | 5.4 | 5.5 | 5.8 | 6.2 | 5.4 | 5.2 |
| Elongation rate (%) | | | 408 | 405 | 380 | 365 | 410 | 408 |
| Durability | Heating | Ratio of | 92 | 92 | 93 | 92 | 91 | 93 |
| | | tensile | | | | | | |
| | | strength | | | | | | |
| | | Ratio of | 91 | 92 | 92 | 93 | 92 | 91 |
| | | elongation | | | | | | |
| | | rate | | | | | | |
| | Accelerated | Ratio of | 95 | 96 | 97 | 96 | 95 | 96 |
| | | tensile | | | | | | |
| | | strength | | | | | | |
| | exposure | Ratio of | 96 | 97 | 95 | 96 | 97 | 96 |
| | | elongation | | | | | | |
| | | rate | | | | | | |

| | | | | | | |
|---|---|---|---|---|---|---|
| Hardness of coating film (Shore A) | 75 | 76 | 78 | 79 | 74 | 72 |
| Solidification and drying (hour) | 17 | 16.5 | 16 | 15.5 | 17 | 14.2 |
| Adhesion (MPa) | 2.8 | 2.7 | 2.9 | 2.8 | 2.8 | 2.7 |
| Working life (minute) | 100 | 98 | 96 | 95 | 99 | 86 |

TABLE 5

| | | | Experimental example | | | | | |
|---|---|---|---|---|---|---|---|---|
| Item | | | 7 | 8 | 9 | 10 | 11 | 12 |
| Tensile strength (MPa) | | | 5.8 | 6.3 | 6.7 | 3.8 | 3.2 | 7.5 |
| Elongation rate (%) | | | 375 | 310 | 300 | 620 | 680 | 250 |
| Durability | Heating | Ratio of | 92 | 93 | 93 | 92 | 92 | 93 |
| | | tensile | | | | | | |
| | | strength | | | | | | |
| | | Ratio of | 92 | 92 | 91 | 93 | 92 | 93 |
| | | elongation | | | | | | |
| | | rate | | | | | | |
| | Accelerated | Ratio of | 96 | 94 | 95 | 94 | 95 | 95 |
| | | tensile | | | | | | |
| | | strength | | | | | | |
| | exposure | Ratio of | 97 | 96 | 95 | 96 | 95 | 95 |
| | | elongation | | | | | | |
| | | rate | | | | | | |

| | | | | | | |
|---|---|---|---|---|---|---|
| Hardness of coating | 77 | 80 | 82 | 62 | 60 | 86 |
| film (Shore A) | | | | | | |
| Solidification and drying (hour) | 17.3 | 13.9 | 14.5 | 28 | 34 | 13.9 |
| Adhesion (MPa) | 2.4 | 2.8 | 2.3 | 2.7 | 2.7 | 2.8 |
| Working life (minute) | 102 | 83 | 88 | 160 | 220 | 84 |

TABLE 6

| | | | Experimental example | | | | | |
|---|---|---|---|---|---|---|---|---|
| Item | | | 13 | 14 | 15 | 16 | 17 | 18 |
| Tensile strength (MPa) | | | 7.8 | 7.3 | 3.8 | 6.7 | 8.2 | 2.9 |
| Elongation rate (%) | | | 200 | 220 | 290 | 300 | 180 | 720 |
| Durability | Heating | Ratio of | 92 | 94 | 92 | 93 | 94 | 92 |
| | | tensile | | | | | | |
| | | strength | | | | | | |
| | | Ratio of | 93 | 92 | 91 | 94 | 92 | 91 |
| | | elongation | | | | | | |
| | | rate | | | | | | |
| | Accelerated | Ratio of | 96 | 93 | 92 | 94 | 95 | 94 |
| | exposure | tensile | | | | | | |
| | | strength | | | | | | |
| | | Ratio of | 96 | 97 | 95 | 94 | 96 | 95 |
| | | elongation | | | | | | |
| | | rate | | | | | | |

| | | | | | | |
|---|---|---|---|---|---|---|
| Hardness of coating film (Shore A) | 87 | 86 | 63 | 80 | 88 | 59 |
| Solidification and drying (hour) | 13 | 14.3 | 12.5 | 24 | 10 | 48 |
| Adhesion (MPa) | 2.6 | 2.7 | 2.6 | 1.8 | 2.4 | 2.5 |
| Working life (minute) | 79 | 103 | 76 | 135 | 60 | 300 |

As shown in Tables 4 to 6 above, the urea coating compositions of experimental examples 1 to 9 according to the present invention showed, on the whole, excellent properties in the measurement items. On the other hand, urea coating compositions of experimental examples 10 to 16 in which the mixing ratio of the first aspartic ester to the second aspartic ester deviates from the ranged according to the present invention, a urea coating composition of an experimental example 17 which does not contain the second aspartic ester, and a urea coating composition of an experimental example 18 which does not contain the first aspartic ester showed at least one inferior properties among tensile strength, elongation rate, hardness of coating film, solidification and drying, adhesion and working life as compared with the experimental examples 1 to 9.

1. A urea coating composition comprising a main part comprising a first aspartic ester and a second aspartic ester at a weight ratio of 3.5 to 5:1; and a curing part comprising an isocyanate,
wherein the first aspartic ester is a standard aspartic ester, and
the second aspartic ester is an ultra-slow drying aspartic ester.

2. The urea coating composition according to claim 1,
wherein the first aspartic ester is produced by a reaction between an alicyclic amine and a maleate, and
the first aspartic ester has a weight average molecular weight of 300 to 1,000 g/mol, an amine equivalent of 100 to 500 g/eq, and an amine value of 50 to 350 mgKOH/g.

3. The urea coating composition according to claim 1,
wherein the second aspartic ester is produced by a reaction between an alkyl group-containing alicyclic amine and a maleate, and
the second aspartic ester has a weight average molecular weight of 300 to 1,000 g/mol, an amine equivalent of 100 to 500 g/eq, and an amine value of 50 to 350 mgKOH/g.

4. The urea coating composition according to claim 1, further comprising 1 to 10% by weight of a high-boiling VOC exempt solvent based on a total weight of the main part,
wherein the high-boiling VOC exempt solvent comprises dimethyl carbonate, parachlorobenzotrifluoride, or the mixture thereof.

5. The urea coating composition according to claim 1,
wherein the main part further comprises a chain extender,
the chain extender comprises one or more selected from the group consisting of a diol, a triol, a tetraol, a diamine and an amino alcohol, and
the chain extender has a weight average molecular weight of 150 to 500 g/mol, an amine equivalent of 50 to 300 g/eq, and an amine value of 250 to 550 mgKOH/g.

6. The urea coating composition according to claim 1,
wherein the isocyanate is a low-viscosity aliphatic isocyanate,
the isocyanate comprises one or more selected from the group consisting of a hexamethylene diisocyanate trimer (HDI trimer), a hexamethylene diisocyanate burette (HDI biuret) and an isophorone diisocyanate trimer (IPDI trimer), and
the isocyanate has an NCO content of 15 to 25% and a viscosity (25° C.) of 100 to 1,000 cPs.

7. The urea coating composition according to claim 1,
wherein the curing part further comprises one or more monomolecular alcohols selected from the group consisting of texanol and ethanol, and
the monomolecular alcohol has a molecular weight of 150 to 250 g/mol and a hydroxyl group value of 200 to 350 mgKOH/g.

8. The urea coating composition according to claim 1,
wherein the urea coating composition comprises 60 to 70% by weight of the first aspartic ester and 10 to 20% by weight of the second aspartic ester based on a total weight of the main part; and 63 to 75% by weight of the isocyanate based on a total weight of the curing part.
